(19) United States
(12) Patent Application Publication
(10) Pub. No.: US 2009/0057160 A1
(43) Pub. Date: Mar. 5, 2009

(54) INTERLEAVED HELICAL COILS ON PERPENDICULAR HEADS

(76) Inventors: Donald G. Allen, Morgan Hill, CA (US); Ming Jiang, San Jose, CA (US); Jennifer Ai-Ming Loo, Fremont, CA (US); Aron Neuhaus, San Jose, CA (US); Vladimir Nikitin, Campbell, CA (US); Yuan Yao, Fremont, CA (US)

Correspondence Address: ZILKA-KOTAB, PC- HIT, P.O. BOX 721120, SAN JOSE, CA, 95172-1120, US

(21) Appl. No.: 11/845,222

(22) Filed: Aug. 27, 2007

(51) Int. Cl. B05D 5/12; C25D 3/48

(52) U.S. Cl. 205/266; 427/58

(57) ABSTRACT

A method for manufacturing a write head with a helical coil having a very small and well controlled spacing between adjacent coil leads. The method includes forming a first set of coil leads, then conformally depositing a thin layer of electrically insulating material such as alumina over the first set of coil leads and over the substrate. An electrically conductive seed layer is then deposited over the thin layer of non-magnetic, electrically insulating material An electrically conductive material such as Cu is then deposited by electroplating in order to form a second set of electrically conductive leads interspersed within the first set of electrically conductive leads, each of the second set of leads being separated from the second set of leads by a portion of the thin layer of non-magnetic, electrically insulating material.

### FIELD OF THE INVENTION

The present invention relates to perpendicular magnetic recording and more particularly to a method for manufacturing a write head having write coils with extremely small spacing between coil leads.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, referred to as a spacer layer, sandwiched between first and second ferromagnetic layers, referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but tree to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to meet the ever increasing demand for improved data rate and data capacity, researchers have recently been focusing their efforts on the development of perpendicular recording systems. A traditional longitudinal recording system, such as one that incorporates the write head described above, stores data as magnetic bits oriented longitudinally along a track in the plane of the surface of the magnetic disk. This longitudinal data bit is recorded by a fringing field that forms between the pair of magnetic poles separated by a write gap.

A perpendicular recording system, by contrast, records data as magnetizations oriented perpendicular to the plane of the magnetic disk. The magnetic disk has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

In order to maximize the performance of such perpendicular write heads, it is desirable to construct the write pole with a spacing between coil leads that is as small as possible. Unfortunately, the ability to reduce the size of the spacing between coil leads has been hindered by manufacturing limitation. Therefore, there is a strong felt need for a write pole design, and or method of manufacturing a write pole that, can allow a write coil to be formed with a very small spacing between leads.

### SUMMARY OF THE INVENTION

The present invention provides a method for manufacturing a write head with a helical coil having a very small and well controlled spacing between adjacent coil leads. The method includes forming a first set of coil leads, then conformally depositing a thin layer of electrically insulating material such as alumina over the first set of coil leads and over the substrate. An electrically conductive seed layer is then deposited over the thin layer of non-magnetic, electrically insulating material. An electrically conductive material such as Cu is then deposited by electroplating in order to form a second set of electrically conductive leads interspersed within the first set of electrically conductive leads, each of the second set of leads being separated from an adjacent lead of the second set of leads by a portion of the thin layer of non-magnetic, electrically insulating material.

The method advantageously allows the spacing between the leads of the coil to be controlled by the thickness of the thin, non-magnetic, electrically insulating layer. Since this deposited thickness can be very accurately controlled down to a very small thickness, this method allows the spacing between the coil leads to be very small and well controlled.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view view, taken from line 3-3 of FIG. 2 and rotated 90 degrees counterclockwise, of a magnetic write head according to an embodiment of the present invention; and

FIGS. 4-18 are cross sectional views of a magnetic write head in various intermediate stages of manufacture, illustrating a method of manufacturing a magnetic write head according to an embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

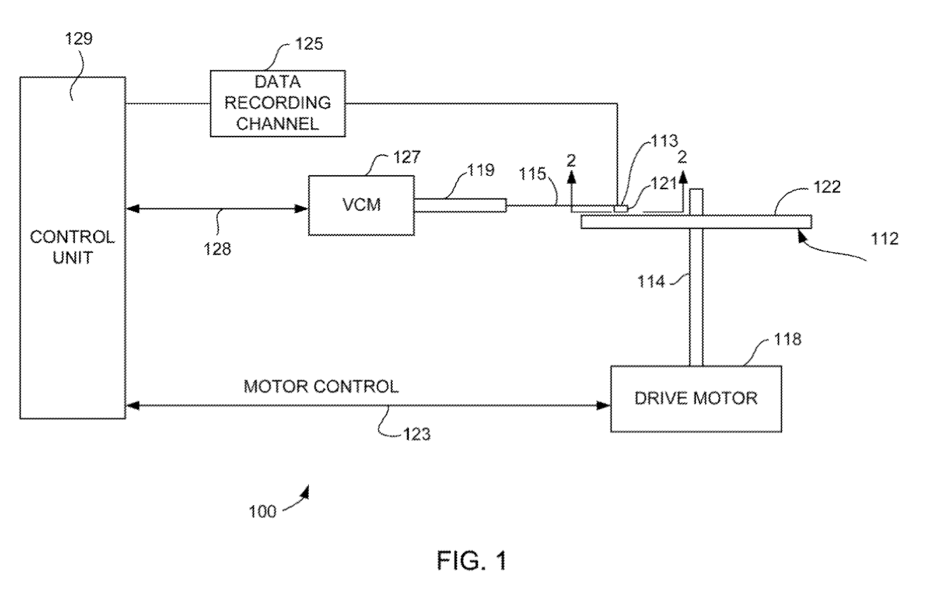

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by die motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances die slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

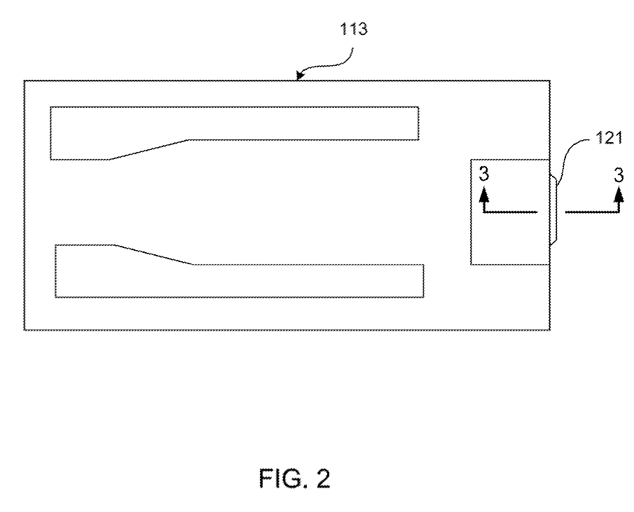

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

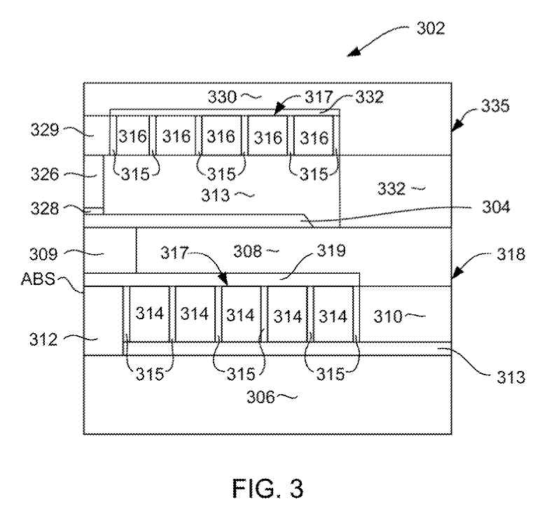

With reference now to FIG. 3, the invention can be embodied in a magnetic write head 302. The write head 302 includes a magnetic write pole 304 and a first or bottom magnetic return pole 306. The write pole 304 can be constructed on a magnetic shaping layer 308. The bottom return pole 306 is magnetically connected with the shaping layer 308 and with the write pole 304 by a first magnetic back gap structure 310. The write pole 304 and first return pole extend to an air bearing surface (ABS). The shaping layer 308 can be separated from the ABS by a non-magnetic fill layer 309 such as alumina. A magnetic pedestal 312 may extend from the trailing edge of the first return pole 306 at the ABS. This pedestal 312 can be useful in preventing stray fields from inadvertently reaching the magnetic medium (not shown). The first return pole 306, first back gap 310, shaping layer 308 and pedestal 312 can be constructed of a material such as NiFe or CoFe. The write pole 304 can be constructed of a high moment magnetic material such as CoFe, and is preferably a laminated structure comprising layers of CoFe separated by thin layers of non-magnetic material.

With reference still to FIG. 3, the write head 302 includes first and second coil leads 314, 316, shown in cross section in FIG. 3, which can be constructed of an electrically conductive material such as Cu. The first and second coil portions 314, 316 are upper and lower portions of a common helical coil 317. The first, or lower coil leads 314 sit atop a layer 313 of non-magnetic, electrically insulating material such as alumina, and are separated from one another by thin layers of a non-magnetic, electrically insulating, conformally deposited material such as alumina 315. A layer of insulating material such as alumina 319 also covers the top of the lower leads 314. Similarly, the upper coil leads are separated from one another by thin, non-magnetic, electrically insulating, conformally deposited layers such as alumina 315.

With reference still to FIG. 3, the write head 302 can include a trailing magnetic shield 326, which can be separated from the trailing edge of the write pole 304 by a trailing gap 328. The trailing shield 326 can be constructed of a magnetic material such as NiFe or CoFe and the trailing gap can be constructed of a non-magnetic material such as alumina (Al₃O₃), Rh, etc.

With reference again to FIG. 3, a second, or upper, return pole 330 can also be provided, and can be constructed to contact the trailing shield 326 and as seen in FIG. 3, the second return pole 330 can be magnetically connected with the trailing shield 326 by a magnetic pedestal structure 329, and also with a second back gap portion 332. The upper return pole 330 is separated from the upper coil leads 316 by an insulation layer 332, which can be, for example, a layer of alumina.

Therefore, as can be seen, the trailing shield 326, write pole 304 and return pole 306 can all be magnetically connected with one another in a region removed from the ABS. The various magnetic structures: first return pole 306, first back gap layer 310, shaping layer 308, write pole 304, second back gap 332, second return pole 330, pedestal 312 and trailing shield 328 together form a magnetic yoke structure 335.

As mentioned above, the lower coil leads 314 are separated from one another by thin insulation layers 315, and, similarly, the upper lead layers 316 are separated from one another by thin insulation layers 315. These thin insulation layers 315, and a novel method for manufacturing the coil leads 314, 316 and insulation layers 315 which will be discussed below, allow the coil leads 314, 316 to be placed very close to one another. Therefore, a write head according to the present invention, can provide maximum write field and minimum coil resistance by having an extremely small spacing between the coil leads 314, 316.

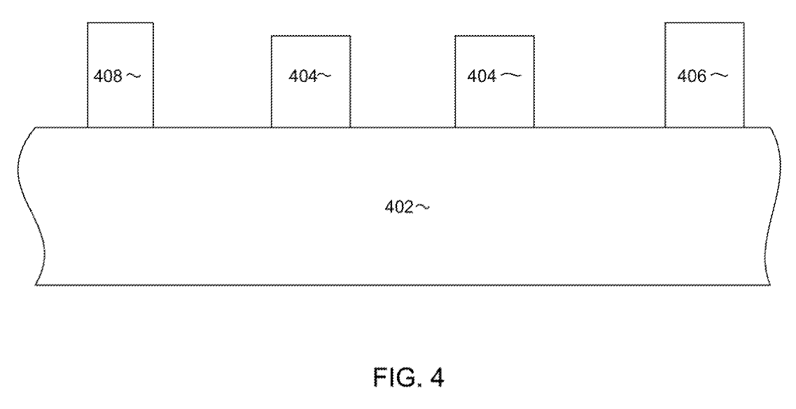

With reference now to FIGS. 4-18, a method for manufacturing a write head according to an embodiment of the invention is described. With particular reference to FIG. 4, a substrate 402 is provided. This substrate 402 can correspond to the lower return pole 306 and insulation layer 313 described above with reference to FIG. 3. A first set of coil leads 404 and magnetic pedestal structures 506, 407 can be formed on the substrate 402. The coil leads 404 can correspond to a portion of the lower leads 314 described with reference to FIG. 3. Similarly, the magnetic pedestal structure 406 can correspond to the back gap layer 310, and the structure 408 can correspond to the magnetic pedestal structure 312 of FIG. 3. The coil leads 404 can be formed before or after the magnetic structures 406, 408, and both structures can be formed by a processes such as forming a photoresist frame, electroplating and lifting off the photoresist. The magnetic pedestal structures 406, 408 can each be constructed of NiFe or some other magnetic material. The coil leads 404 can be constructed of an electrically conductive material such as Cu.

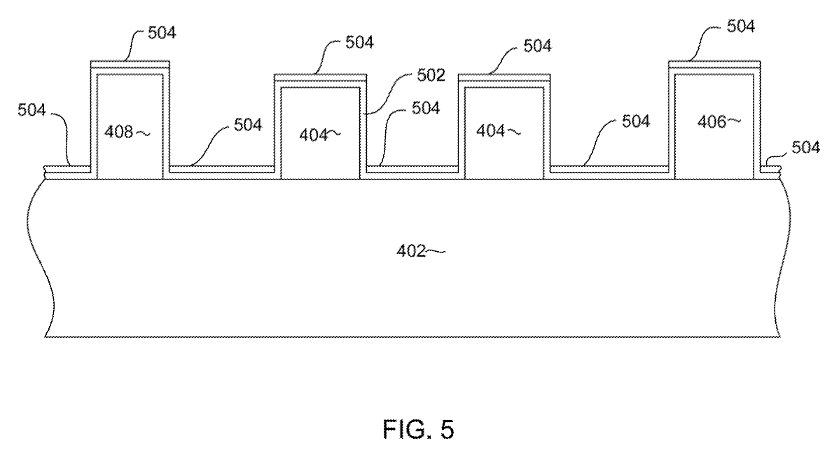

With reference now to FIG. 5, a layer of electrically insulating material 502 such as alumina Is deposited by a conformal deposition method such as atomic layer deposition (ALD) or chemical vapor deposition (CVD). For purposes of simplicity, the layer 502 will be referred to as ALD layer 502. The ALD layer 502 can be deposited to a thickness of, for example, 20-100 nm, depending on what spacing is desired between the lead layer 314 in the finished head (FIG. 3). After the ALD layer 502 has been deposited, an electrically conductive seed layer 504 is deposited. The seed layer 504 can be constructed of several electrically conductive materials, such as Au or NiFe, and is preferably deposited by a method such as ion beam deposition (IBD) which deposits mostly on the horizontally disposed surfaces, leaving relatively little material deposited on the sides of the coil structure. This assists in avoiding the formation of voids during a subsequent electroplating process that will be described herein below.

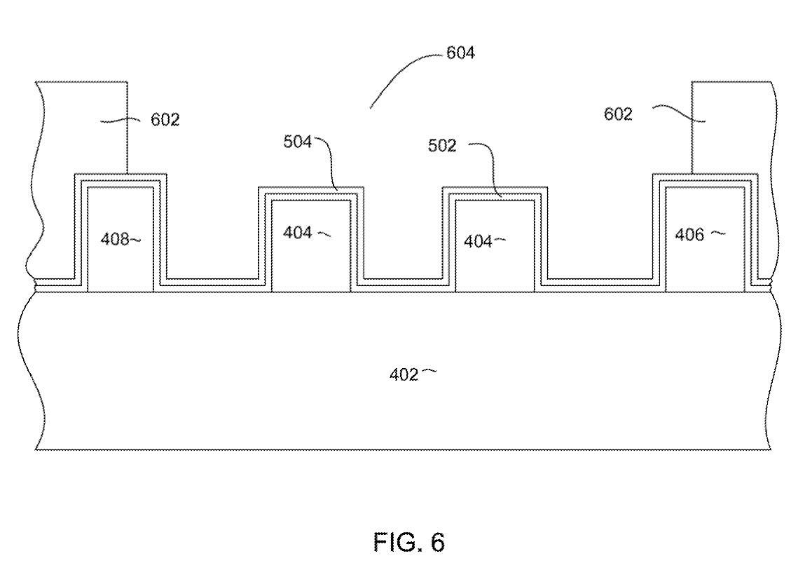

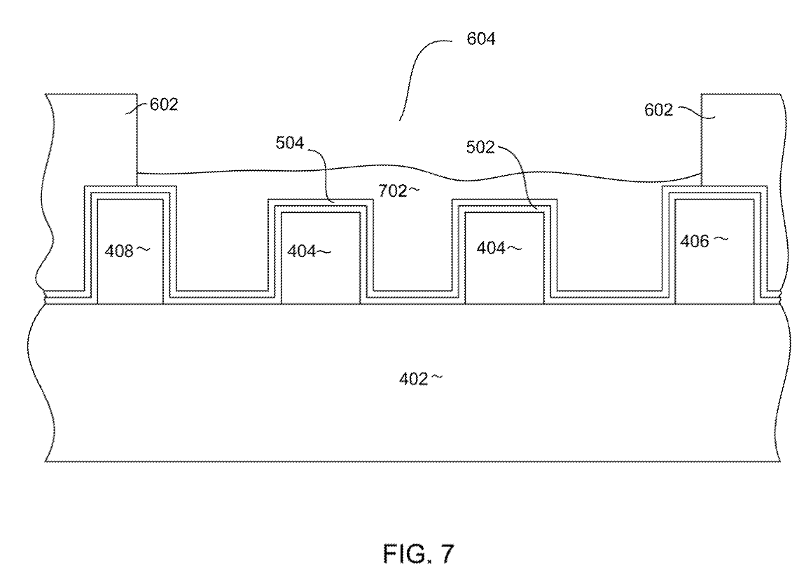

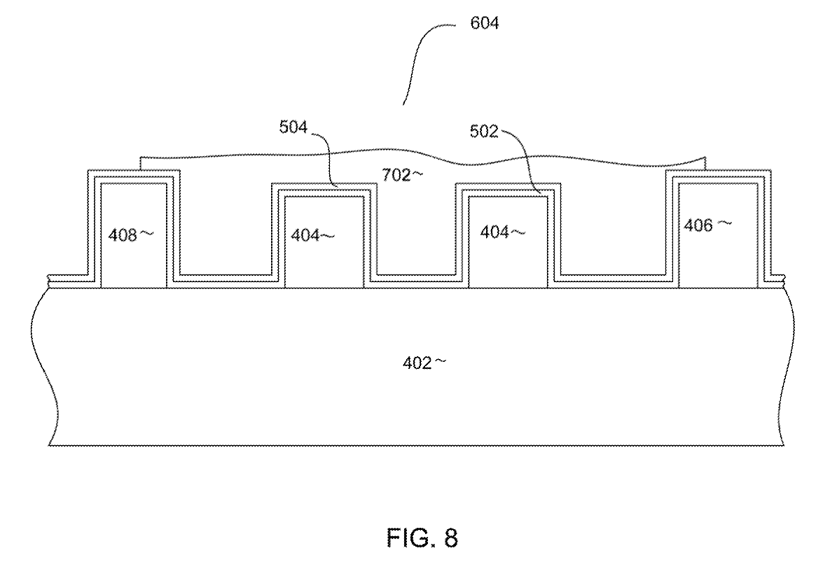

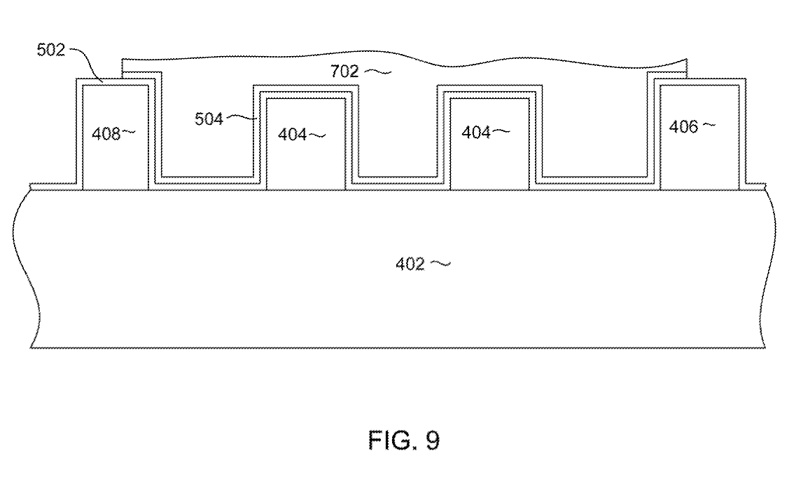

With reference to FIG. 6 a photoresist mask 602 is formed to cover areas outside of a coil region 604, and leaving the coil region 604 uncovered. Then, with reference to FIG. 7, an electrically conductive material such as Cu 702 is deposited into the coil area 604 by electroplating, using the seed layer 504 as an electroplating seed. Then, the photoresist mask 602 can be lifted off resulting in a structure as shown in FIG. 8. Then, with reference to FIG. 9, material removal process such as ion milling or sputter etching is performed to remove portions of the seed layer extending outside of the coil area 604, i.e. removing the seed from the field. The material removal process used to remove the seed layer should chosen so as not to result in any re-deposition of seed material, since there should be no Cu or similar material at the air bearing surface in the finished write head.

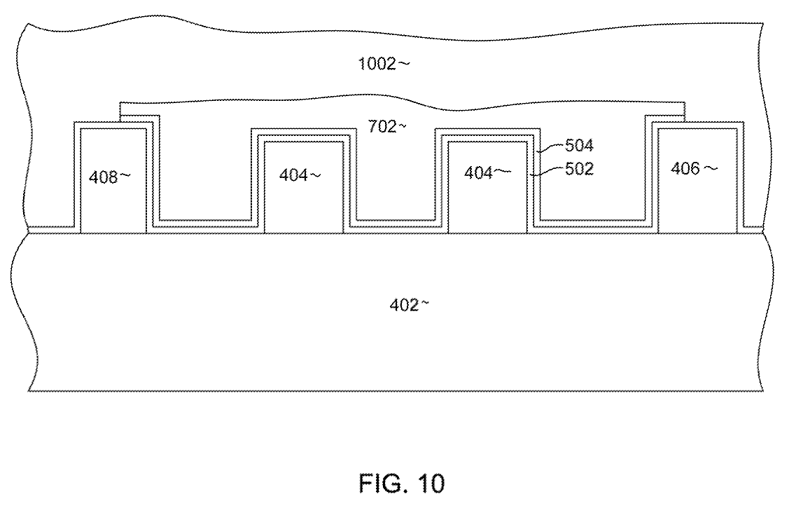

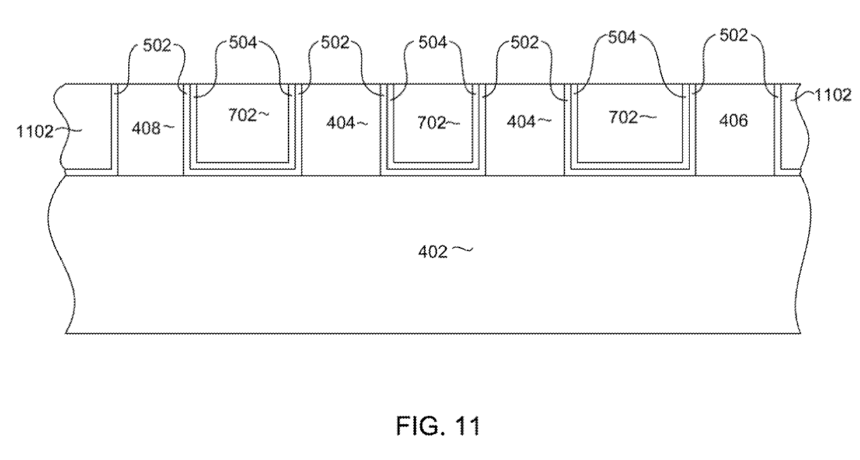

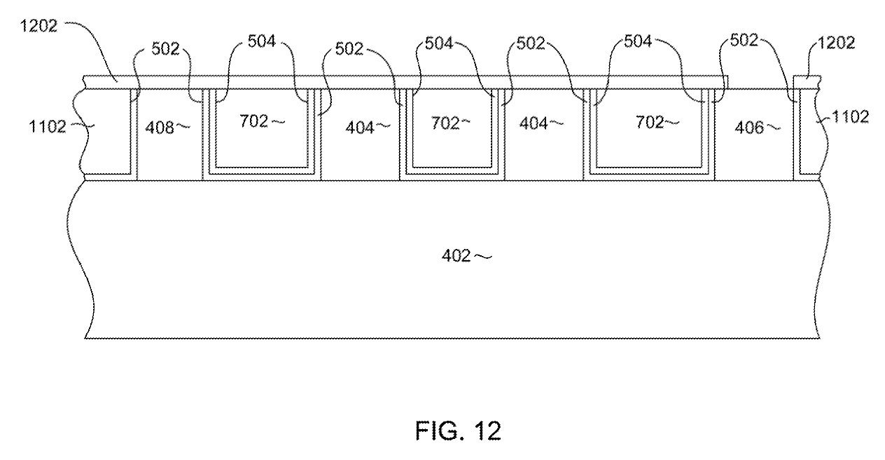

With reference now to FIG. 10, an alumina fill layer 1002 can be deposited full film. Then, a chemical mechanical polishing process (CMP) is performed, resulting in the planarized structure shown in FIG. 11. Then, with reference to FIG. 12, an insulation layer 1202, such as alumina is deposited. The insulation layer is formed with an opening over the magnetic pedestal structure 406. This opening can be formed by a photoresist liftoff process.

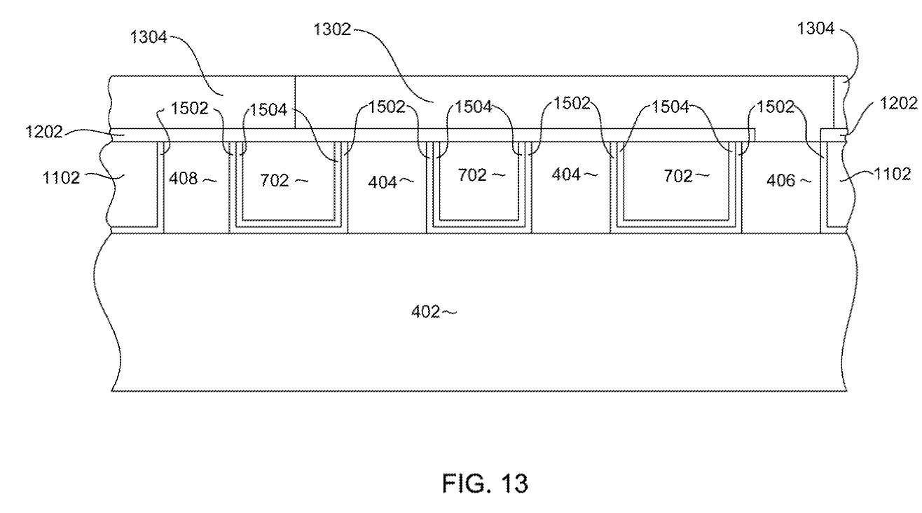

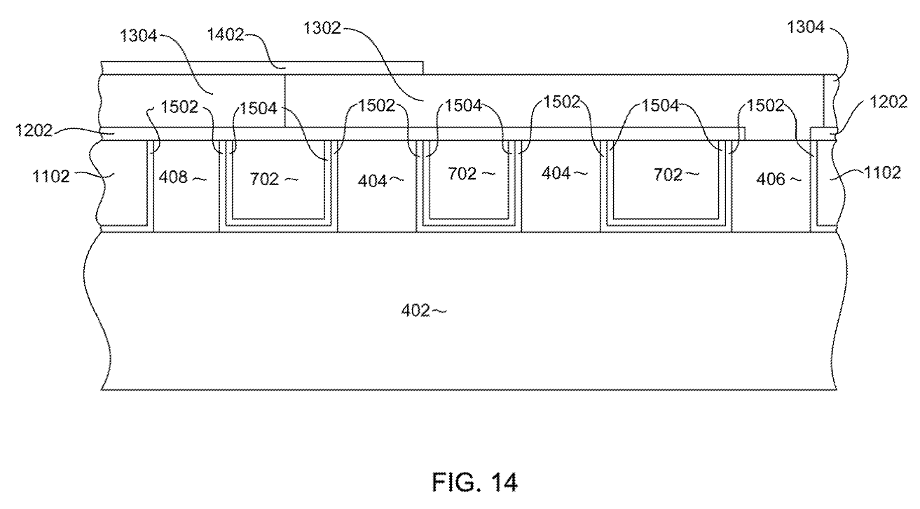

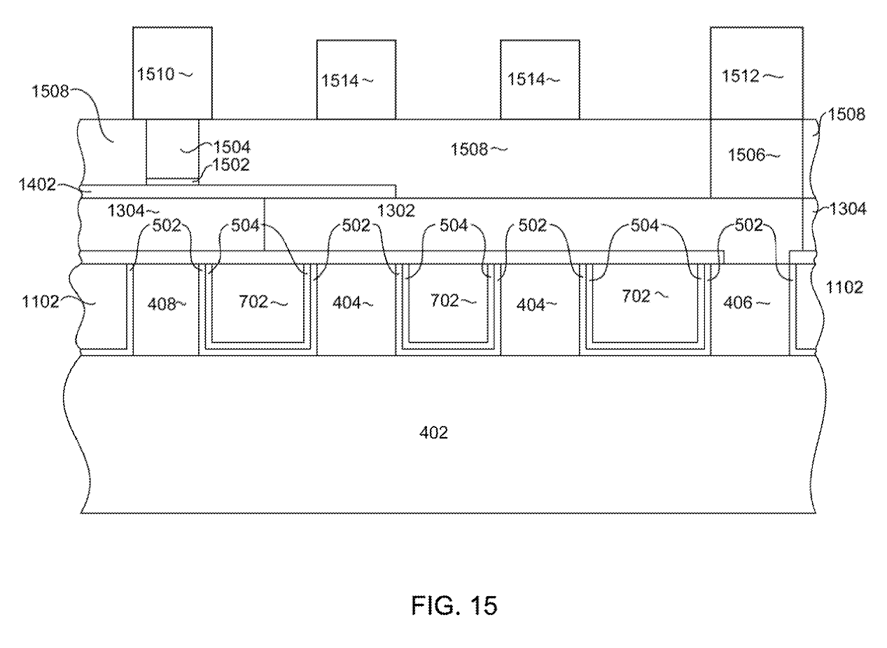

Then, with reference to FIG. 13, a magnetic shaping layer 1302 and insulation fill layer 1304 are formed. The magnetic shaping layer 1302 can be constructed of a material such as NiFe and the fill layer 1304 can be alumina. The shaping layer 1302 and fill layer 1304 can be formed by a series of photoresist masking and deposition steps followed by a CMP process to planarize the surfaces of the layers 1302, 1304. Then, with reference to FIG. 14 a write pole 1402 can be formed. The write pole 1402 can be constructed as a lamination of magnetic layers separated by thin non-magnetic layers. Then, with reference to FIG. 15, a non-magnetic trailing shield gap 1502 and magnetic trailing shield 1504 are formed. A second magnetic back gap pedestal 1506 is also formed, and an insulation fill layer 1508 such as alumina is deposited to surround the trailing shield 1504 and back gap 1506. A CMP process is performed to planarized the surfaces of the trailing shield 1504, back gap 1506 and fill layer 1508. The trailing shield 1504 can also be configured as a trailing, wrap around shield that wraps around the sides of the write pole 1402.

With continued reference to FIG. 15, a magnetic pedestal 1510 and third back gap pedestal 1512 are constructed. A plurality of electrically conductive upper coil lead layers 1514 are also constructed between the pedestal 1510 and back gap 1512, The electrically conductive lead layers 1514 correspond to a portion of the upper coil lead layers 316 described with reference to FIG. 3, and can be constructed before or after the pedestal 1510 and back gap 1512.

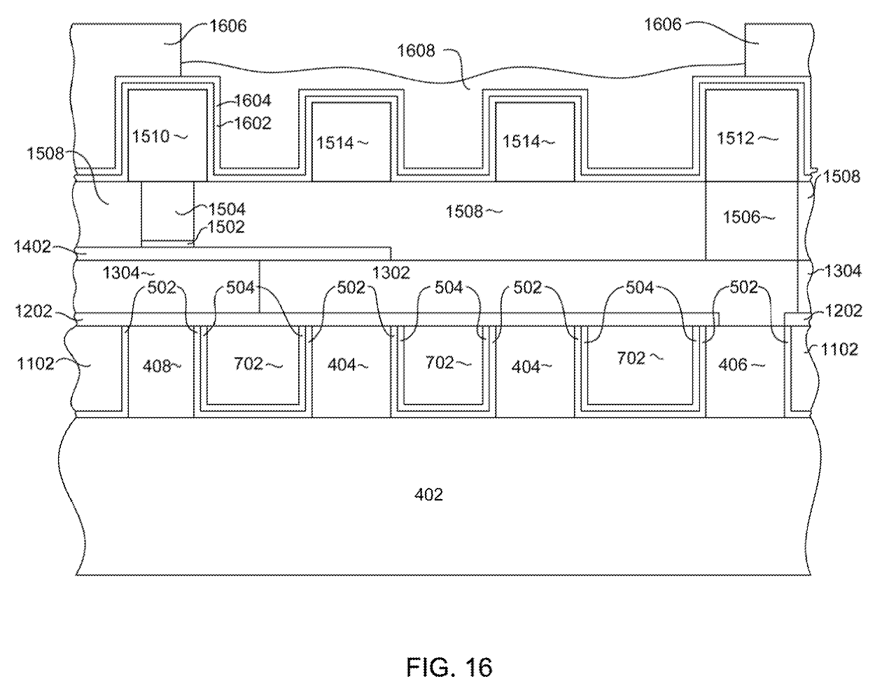

With reference now to FIG. 16, a thin layer of non-magnetic, electrically insulating material such as alumina 1602 is conformally deposited, followed by an electrically conductive seed layer 1604. Then, a photoresist mask 1606 is formed to cover areas outside of a coil area, and an electrically conductive material 1608 such as Cu is deposited to form coil leads between the leads 1514 formed earlier.

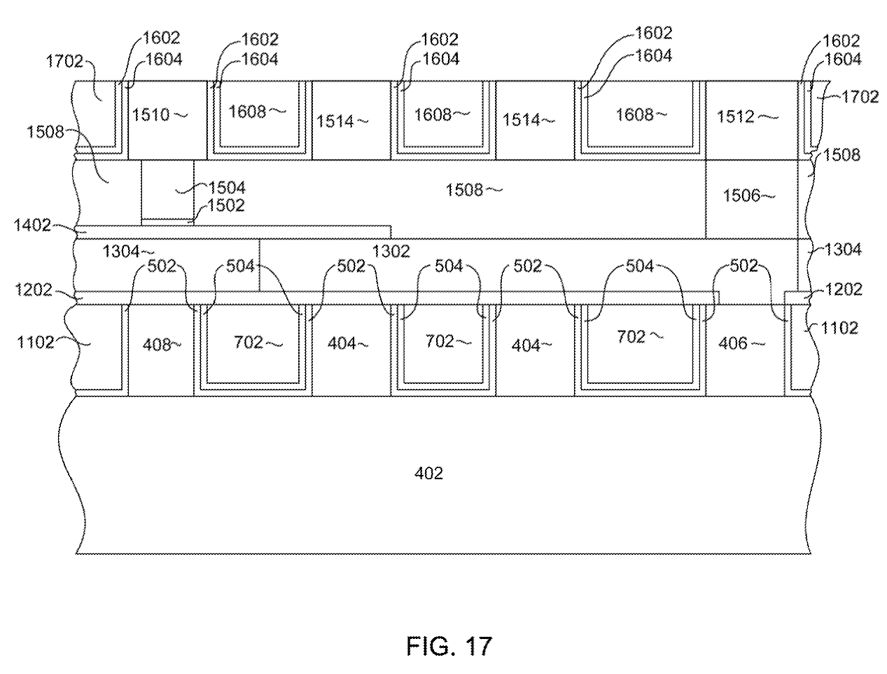

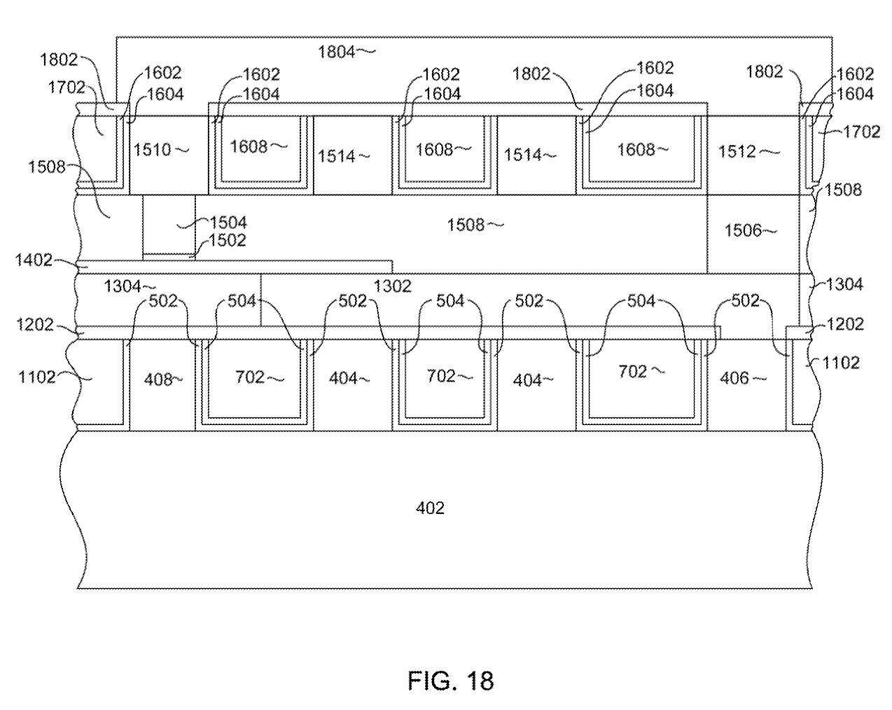

Then, with reference to FIG. 17, the mask 1606 (FIG. 16) is lifted off, a fill layer such as alumina 1702 is deposited, and a CMP process is performed to planarize the surfaces of the layers 1510, 1514, 1512, 1702. With reference to FIG. 18, an insulation layer 1802 is formed leaving areas over the pedestal 1510 and hack gap 1512 uncovered. A magnetic top pole layer 1804 can then be formed, and can be constructed of a material such as NiFe.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic write head, comprising:
providing an electrically insulating substrate;
forming a first set of electrically conductive coil leads over the electrically insulating substrate;
depositing a layer of non-magnetic, electrically insulating material over the first set of coil leads; and
depositing an electrically conductive material to form a second set of electrically conductive coil leads interposed between the first set of electrically conductive coil leads, the first set of coil leads being separated from the second set of coil leads by the non-magnetic, electrically insulating material.

2. A method as in claim 1, further comprising, after depositing the electrically conductive material to form a second set of electrically conductive coil leads interposed between the first set of electrically conductive coil leads, performing a chemical mechanical polish (CMP).

3. A method as in claim 1 wherein die depositing a non-magnetic, electrically insulating material comprises a conformal deposition process.

4. A method as in claim 1 wherein the non-magnetic, electrically insulating material is deposited by atomic layer deposition (ALD).

5. A method as in claim 1 wherein the non-magnetic, electrically insulating material is deposited by chemical vapor deposition (CVD).

6. A method as in claim 1 wherein the non-magnetic, electrically insulating material comprises alumina.

7. A method as in claim 1 wherein the non-magnetic, electrically insulating material comprises alumina deposited by atomic layer deposition (ALD).

8. A method as in claim 1 wherein the depositing a non-magnetic electrically insulating material comprises depositing alumina by atomic layer deposition (ALD) and wherein the depositing an electrically conductive material to form a second set of electrically conductive coil leads interposed between the first set of electrically conductive coil leads comprises electroplating.

9. A method as in claim 1 wherein the layer of non-magnetic, electrically insulating material has a thickness of 20-100 nm.

10. A method as in claim 1 wherein the depositing an electrically conductive material to form a second set of electrically conductive coil leads comprises first depositing an electrically conductive seed layer using ion beam deposition, and then electroplating an electrically conductive material using the electrically conductive seed layer as an electroplating seed.

11. A method as in claim 10 wherein the electrically conductive seed layer comprises Au.

12. A method as in claim 10 wherein the electrically conductive seed layer comprises NiFe.

13. A method for manufacturing a helical write coil in a magnetic write head, comprising:
providing a substrate;
forming a first set of electrically conductive leads over the substrate;
performing a conformal deposition process to deposit a thin layer of electrically insulating material over the substrate and over the first set of electrically conductive leads:
depositing an electrically conductive seed layer over the thin layer of electrically insulating material;
forming a photoresist mask structure, the photoresist mask structure having an opening over coil region;
performing an electroplating process to deposit an electrically conductive material into the opening of the photoresist mask structure to form a second set of electrically conductive leads interspersed within the first set of electrically conductive leads;
removing the photoresist mask structure;
depositing an electrically insulating fill layer; and
performing a chemical mechanical polish (CMP).

14. A method as in claim 13 wherein the depositing an electrically conductive seed layer comprises ion beam deposition (IBD).

15. A method as in claim 13 wherein the performing a conformal deposition process to deposit a thin layer of electrically insulating material over the substrate and over the first set of electrically conductive leads comprises depositing alumina by atomic layer deposition.

16. A method as in claim 13 wherein the performing a conformal deposition process to deposit a thin layer of electrically insulating material over the substrate and over the first set of electrically conductive leads comprises depositing alumina by chemical vapor deposition.

17. A method as in claim 1 wherein the thin electrically insulating layer is deposited to a thickness chosen to define a spacing between a lead of the first, set of electrically conductive leads and a lead of the second set of electrically conductive leads.

18. A method as in claim 13 wherein the thin electrically insulating layer is deposited to a thickness chosen to define a spacing between a lead of the first set of electrically conductive leads and a lead of the second set of electrically conductive leads.

19. A method as in claim 13 wherein the thin layer of electrically insulating material is deposited to a thickness of 20 or greater.

20. A method as in claim 13 wherein the electrically insulating fill layer comprises alumina.
